(19) United States
(12) Patent Application Publication
(10) Pub. No.: US 2006/0194625 A1
(43) Pub. Date: Aug. 31, 2006

(54) Mobile electronic device carrier allowing selective opening of the electronic device

(75) Inventors: Adrian P. Davis, Hallandale, FL (US); Frank Chandler, Plantation, FL (US); Mohammad T. Khalid, Boca Raton, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/067,937

(22) Filed: Feb. 28, 2005

(51) Int. Cl. H04M 1/00

(52) U.S. Cl. 455/575.8

(57) ABSTRACT

A portable electronic device carrier (100) includes a base (105) having a resting portion (110) which slidably receives an electronic device (200) for securing the electronic device in a stored position. The base further includes a projection (120) extending from the base and positioned to engage the electronic device where the projection selectively alters the state of the electronic device when the electronic device is removed from the stored position along a first path (300) and fails to alter the state of the electronic device when the electronic device is removed along a second path (400).

### CROSS REFERENCE TO RELATED APPLICATIONS

Not Applicable.

### FIELD OF THE INVENTION

This invention relates to the field of mobile electronic devices, and more particularly, to carriers for mobile electronic devices that are arranged to transform between open and closed configurations.

### BACKGROUND

In recent years, mobile electronic products have become quite popular as many people need access to these products and do not have the luxury of being able to reside in a single office location. The mobile phone is one example of a mobile electronic device that has seen rapid adoption for business use and for personal use. Frequently, users of such a device need to carry these devices on their person throughout most of the day. In the beginning, many users simply carried their mobile phone in their pockets or in hand bags. Shortly thereafter, carriers were developed to store the mobile phone on the person while keeping the phone highly accessible. One example of such a device is a mobile phone carrier that clips to the belt or pant waist seam of the user for holding the device on the user's hip. Although the belt clip carrier has provided a convenient apparatus for storing the mobile phone in an accessible location, the belt clip carrier does have limitations.

Current belt clip carriers are not always designed to allow the user to easily store the mobile phone when not in use and to access the mobile phone when needed. For instance, with a clamshell or flip phone, it is commonplace that when a user receives a call and the mobile phone is stored in a belt clip carrier, the user must remove the phone from the carrier and then manually activate the phone for use by using both hands to open the phone to the in-use configuration. In many instances, the user may not be able to complete all of the steps necessary to activate the phone and answer the call before the call is dropped. Additionally, the process of removing the phone and manually opening the phone requires both hands, making such a process interrupt whatever activity the user was currently undertaking.

### SUMMARY OF THE INVENTION

Embodiments in accordance with the present invention provide a portable electronic device carrier that offers the option of selectively altering the state of the electronic device when removing the device from the carrier. The invention also provides for the option of not altering the state of the electronic device when removing the device from the carrier. Therefore, the carrier provides the user with greater control and ease of use of the electronic device.

A portable electronic device carrier can include a base having a resting portion which slidably receives an electronic device for securing the electronic device in a stored position and a projection extending from the base and positioned to engage the electronic device. The projection can selectively alter the state of the electronic device when the electronic device is removed from the stored position along a first path. Additionally, the electronic device in one embodiment can pivot to transform between open and closed configurations and the projection can be positioned to engage a surface of the electronic device. Accordingly, the projection provides for selectively transforming the electronic device to the open configuration when the device is removed from the stored position along the first path and fails to transform the electronic device to the open configuration when the device is removed from the stored position along a second path. The base can also include a top portion opposite to the resting portion, the projection is located between the top portion and the resting portion offset from the pivot of the electronic device.

In one embodiment, the projection can form a hook that engages the electronic device at a channel formed by the meeting of pivoting portions of the electronic device. The projection can also form a hook that engages the electronic device at an indentation formed on the electronic device at a meeting of the pivoting portions of the electronic device. Additionally, the projection can be biased such that the projection flexes to enable the electronic device to slide into the stored position and the projection returns to an un-flexed position to engage the surface of the electronic device.

In another embodiment, a mobile electronic device for use with an electronic device holder is provided. The mobile electronic device can be slidable into an electronic device holder for securing the electronic device in a stored position and can have a pivotable portion. The pivotable portion can align with a projection extending from a base of the electronic device carrier such that the pivotable portion is positioned to engage the projection. Also, the pivotable portion can be engaged by the projection to selectively alter the state of the electronic device when the electronic device is moved from the stored position along a first path. The electronic device carrier can slidably receive the mobile electronic device for securing the electronic device in a stored position.

In one arrangement, the electronic device can pivot to transform between open and closed configurations and the projection is positioned to engage a surface of the electronic device. The pivotable portion can be engaged by the projection to selectively pivot the electronic device to the open configuration when the device is removed from the stored position along the first path whereas when the device is removed from the stored position along a second path the pivotable portion fails to engage with the projection and otherwise fails to pivot the electronic device to the open configuration. Additionally, the pivoting portion of the electronic device can form a channel at the point where the projection engages the electronic device and the electronic device can include an indentation at the meeting of the pivoting portion of the electronic device where the projection engages the electronic device. The indentation can be offset from the pivot of the electronic device. Also, the electronic device can include a delay such that the state of the electronic device is altered after the commencement of the pivoting.

Also in accordance with the inventive arrangement, a system or method of altering the state of an electronic device is provided. The method can include providing an electronic device having a pivotable portion and providing an electronic device carrier having a base with a resting portion and with a projection extending from the base and positioned to engage the electronic device. The method can also include selectively removing the electronic device along a first path to alter the state of the electronic device or selectively removing the electronic device along a second path to purposely fail to alter the state of the electronic device.

In another arrangement, the system or method can include selectively engaging the pivotable portion of the electronic device with the projection and transforming the pivotable portion of the electronic device to an open configuration to selectively alter the state of electronic device. Also, the method can include returning the electronic device to the carrier such that the projection is positioned to engage the pivotable portion.

The aspects above will be better understood with reference to the following figures and detailed description. It should be appreciated that the particular devices and methods illustrating the embodiments of the present invention are exemplary only and not to be regarded as limitations thereof.

### BRIEF DESCRIPTION OF THE DRAWINGS

There are presently shown in the drawings various embodiments, it being understood, however, that the embodiments and claims herein are not limited to the precise arrangements and instrumentalities shown.

FIG. 1 is a perspective view of one embodiment of a portable electronic device carrier in accordance with an embodiment the inventive arrangements.

FIG. 2 is a perspective view of the portable electronic device carrier of FIG. 1 with a portable electronic device in a closed configuration and stored position.

FIG. 3 is a side view of the portable electronic device carrier of FIG. 1 with a portable electronic device in transition of being removed from the stored position of FIG. 2 along a first path.

FIG. 4 is a side view of the portable electronic device carrier of FIG. 1 with a portable electronic device in transition of being removed from the stored position of FIG. 2 along a second path.

FIG. 5 is a chart illustrating the steps of a system of selectively altering the state of an electronic device in accordance with an embodiment of the present invention.

### DETAILED DESCRIPTION

Embodiments herein provide an elegant solution to enable a user to simultaneously remove an electronic device from a carrier and reconfigure the electronic device for immediate use. Embodiments herein also provide the user with the flexibility to remove the electronic device from a carrier without reconfiguring the electronic device for immediate use.

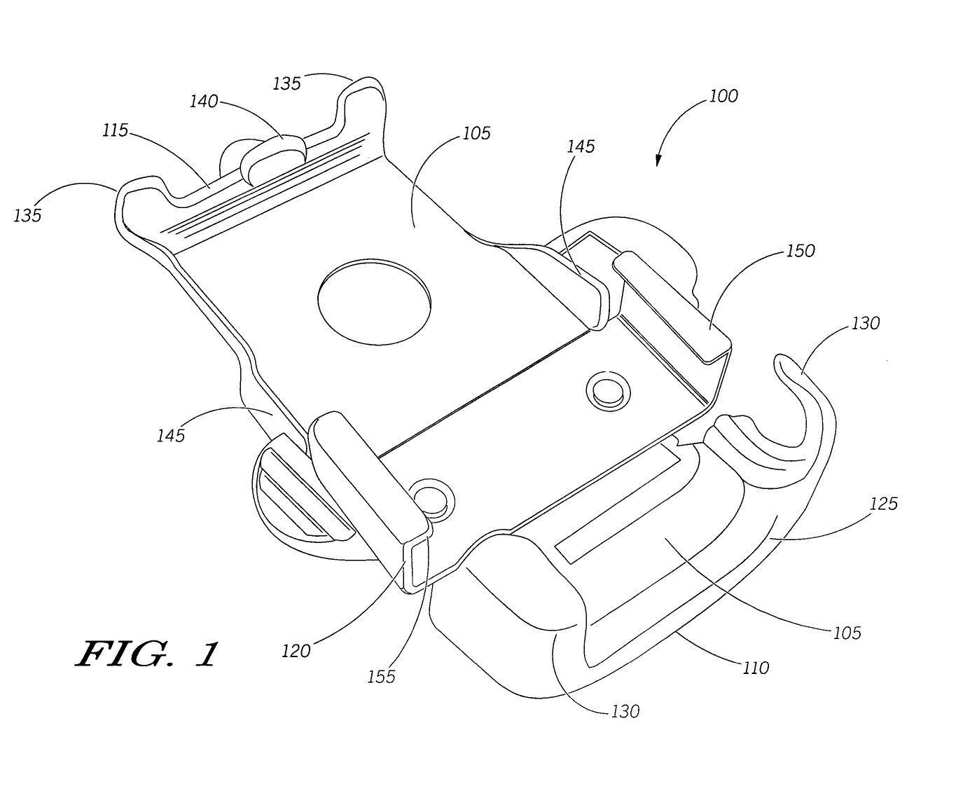

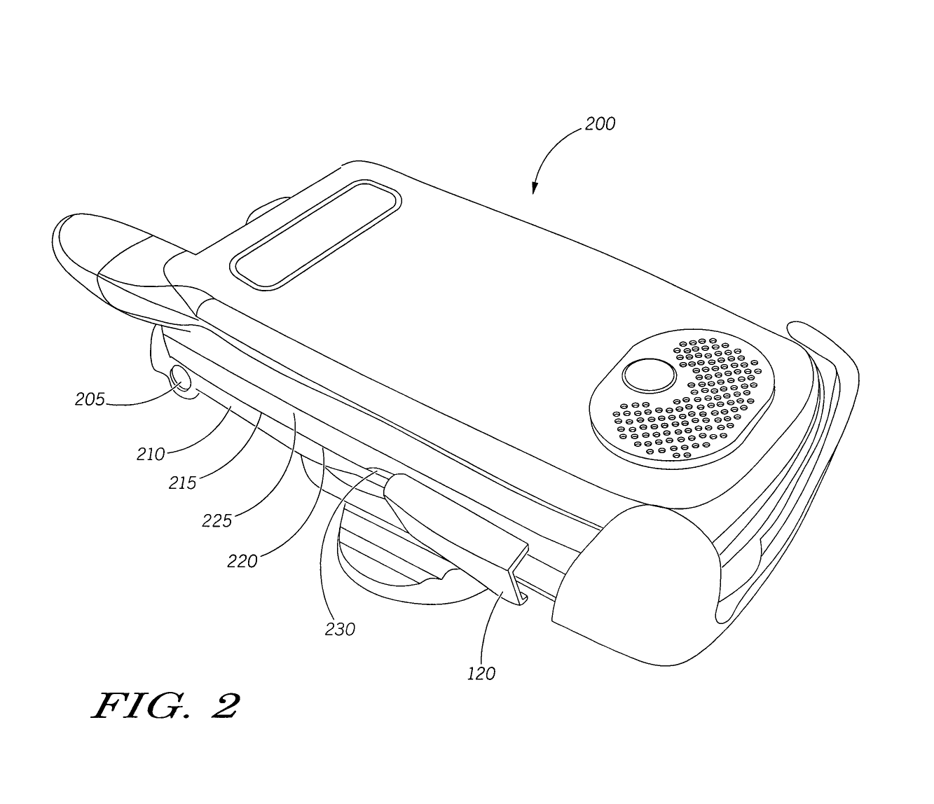

An exemplary embodiment of an electronic device carrier 100 is shown in FIGS. 1 and 2. The carrier 100 includes a base 105, a resting portion 110, a top portion 115 and a projection 120. As shown in FIG. 2, the carrier 100 can hold and secure, in a stored position, an electronic device 200 having a pivot 205 and a pivoting portion 210. As used herein, the stored position includes any configuration of the electronic device 200 secured to the carrier 100.

The resting portion 110 can include a lip 125 to provide support to the electronic device 200 placed in the carrier 100. The resting portion 120 can also include curved or angled support hooks 130 located laterally on the resting portion 110 and protruding from the base 105. The support hooks 130 can be dimensioned to wrap around a portion of an electronic device 200 to secure the electronic device 200 to the carrier 100.

The top portion 115 can include curved or angled support protrusions 135 that extend from the base 105. The protrusions 135 can be located laterally on the top portion 115 to engage the lateral portions of an electronic device 200. A medially located protrusion 140 can also extend from the top portion 115 to help secure the electronic device 200 to carrier 100.

The base 110 can also include flanges 145 located laterally on the base 105. Although FIG. 1 shows only one pair of flanges 145, multiple flanges 145 can be provided to help secure the electronic device 200 in the carrier 100.

The top portion 115 with protrusions 135 and 140, the resting portion 110 with lip 125 and support hooks 130, and the flanges 145 can secure an electronic device 200 to carrier 100. These components can be dimensioned and located relative to each other so that an electronic device 200 can fit snuggly within the carrier 100. Additionally, having base 105 with a top portion 115, a resting portion 110, and flanges 145 allows the carrier 100 to support various shaped electronic devices 200. Additionally, the dimensions and locations of the components enables the electronic device 200 to slide into the stored position. Some or all of the components may be slightly flexible to allow for the electronic device 200 to be forced into the stored position where the components provide a snug fit.

The projection 120 can extend from the base 105 and can form a hook or angled portion 150 with tip 155. The tip 155 can extend medially relative to the base 105 for engaging portions of the electronic device 200. As merely an example, the distance of medial extension can be less than one fourth of the length of the width of the base 105; however, it should be noted that the distance of medial extension may be any suitable distance for engaging the electronic device 200 and may be adjusted depending upon the electronic device 200.

Additionally, the projection 120 can be positioned on the base 105 between the resting portion 110 and the top portion 115. In one arrangement, the projection 120 can be positioned at a distance that is offset from the end of the base 105 where the pivot 205 of electronic device 200 will be located when the electronic device 200 is in the stored position. Further, the projection 120 can be located between flanges 145 and the resting portion 110 or the projection 120 can be located between flanges 145 and the top portion 115. Nevertheless, the positioning of the projection 120 is not limited as it can be positioned generally equidistant between top portion 115 and resting portion 110 or can be offset as desired.

The projection 120 extends from the base 105 a distance at which the tip 155 of the curved portion 150 will engage the electronic device 200. In one example with a common clam style mobile phone with two relatively equal sized halves, the projection 120 can extend from the base 105 to the point at which the two halves meet. In this example, the projection 120 may extend approximately half of the thickness of the clam style phone, which is secured in the closed position by support hooks 130. Thus, the projection 120 can extend from the base approximately one half of the distance that the support hooks 130 extend from the base 105. Nevertheless, the invention is not limited in this regard as the projection 120 can extend any suitable distance from the base 105 as needed. For instance, if the pivotable portion 210 of an electronic device 200 is relatively thin in comparison to the body 225 of the electronic device 200, it may be suitable for the projection 120 to extend a distance smaller than one half of the distance that the support hooks 130 extend from the base 105.

In one arrangement as illustrated in FIG. 2, the electronic device 200 is shown in a closed configuration in the stored position where the electronic device 200 is secured to the carrier 100. In this arrangement, the projection 120 is positioned offset from the end of the base 105 at which the pivot 205 is located. The projection 120 is shown in a flexed arrangement, where the projection is flexed slightly outward by the electronic device 200 and biased to return to the un-flexed arrangement shown in FIG. 1. The biased projection 120 provides an additional amount of support to secure the electronic device 200 to carrier 100.

Additionally, the biased projection 120 can naturally move to its unbiased arrangement during the process of removing the electronic device 200 from the carrier 100. When the projection 120 moves to its unbiased position, the tip 155 of projection 120 can engage a surface 215 of the pivoting portion 210 of the electronic device 200. Consequently, the tip 155 can engage the surface 215 of the electronic device 200 at the channel 220 formed by the meeting of the pivoting portion 210 with the body 225 of the electronic device 200.

Further, the body 225 can include an indentation 230 to lesson the amount of flexing by the projection 120. The tip 155 of projection 120 can be positioned along the length of base 105 to correspond with the indentation 230 and can engage the pivotable portion 210. In one arrangement, the indentation 230 can allow the projection 120 to rest in an unbiased arrangement so that the projection 120 is not in a flexed position while the electronic device 200 is in the stored position.

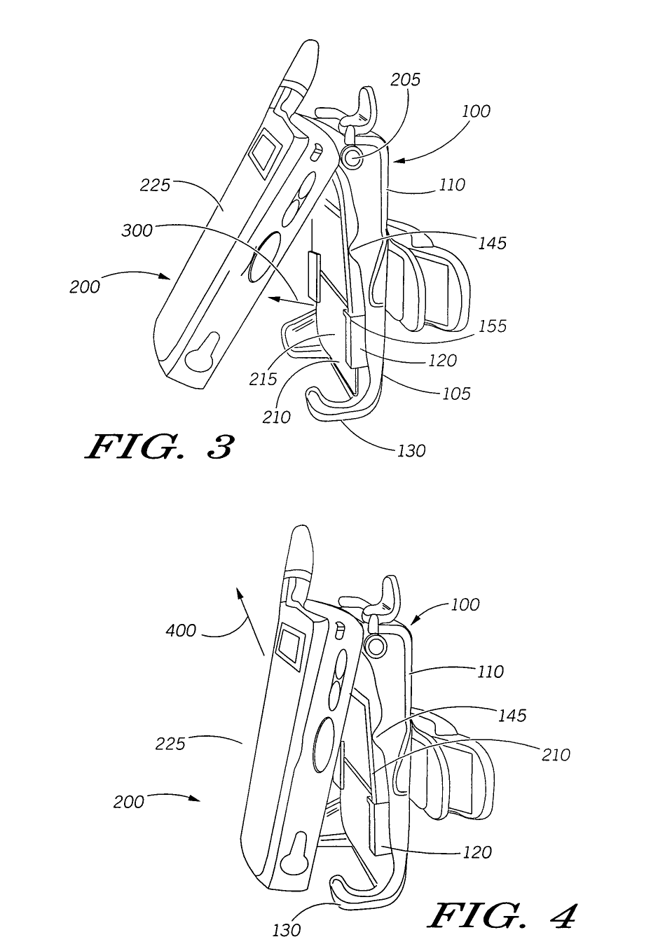

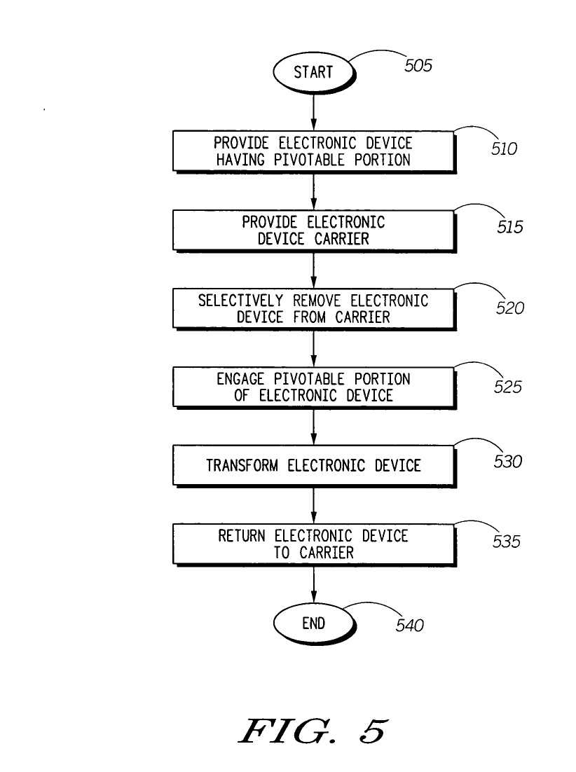

In operation and referring to FIGS. 3 and 4, FIG. 3 illustrates that the electronic device 200 can be removed from carrier 100 along a first path 300 such that the projection 120 engages a surface 215 of the pivotable portion 210 and the projection selectively alters the state of the electronic device 200. In contrast, FIG. 4 illustrates that the electronic device 200 can be removed from the carrier 100 along a second path 400 such that the projection selectively fails to alter the state of the electronic device 200.

As used herein, the phrase “alters the state” refers to the process of changing the current operation of the electronic device to a different operation. As one example with a mobile phone, the state of the phone can be altered from standby state, corresponding to simply waiting to receive a phone call, to the in use state, corresponding to answering the call and supporting a conversation. Although in this previous example the mobile phone was powered on before the state was altered, altering the state can include changing from a non-powered state to a powered state. Also, “alters the state” can further mean altering the configuration of the device in either an electronic or mechanical sense. The example above demonstrates an electronic state alteration, whereas merely changing a flip phone from a closed position to an open provides an example of a mechanical state alteration.

Additionally, the term “selectively” refers to the optional functionality provided by the arrangements discussed herein. The projection 120 provides for the options of altering the state of the electronic device 200 or failing to alter the state of the electronic device 200. Thus, a selective alteration of the state of the electronic device is in contrast to an arrangement without an option of altering the state of the electronic device 200 or not altering the state of the electronic device 200.

When the electronic device 200 is removed from the stored position along the first path 300 as shown in FIG. 3, the projection 120 selectively alters the state of the electronic device 200. In this example, the first path is in the general orientation of being generally normal from the base 105 of the carrier 100 as shown by the solid arrow. Nevertheless, the invention is not limited in this regard as the first path can be any suitable path that results in the selective alteration of the state of the electronic device 200.

In removing the electronic device 200 along the first path 300, the tip 155 of the projection 120 can engage a surface 215 of pivotable portion 210. In turn, the engagement of surface 215 by tip 155 can cause the electronic device 200 to transform from a closed configuration to an open configuration by pivoting portion 210 on pivot 205. Additionally, it should be noted that positioning the projection 120 offset from the end of the base 105 at which the pivot 205 is located, can provide leverage for ease of pivoting the portion 210. With the state of the electronic device 200 altered and the electronic device 200 transformed to the open configuration, the user can now easily use the electronic device 200.

In contrast, the electronic device 200 can be removed from the stored position along the second path 400 as shown in FIG. 4. When the electronic device 200 is removed along the second path 400, the projection 120 fails to alter the state of the electronic device 200. The projection 120 fails to alter the state of the electronic device 200 because removing the electronic device along the second path 400 fails to cause the projection 120 to engage the pivotable portion 210 or to cause the pivoting portion 210 to pivot and transform the electronic device 200 to the open configuration. Thus, the state of the electronic device 200 remains constant, which can allow for a user to remove the electronic device 200 from the stored position without intent to immediately use the electronic device 200. In this example, the second path is illustrated as being orientated as a small angle with the base 105 of carrier 100. For instance, the angle shown may be approximately 15°; however, any angle offset from the generally perpendicular orientation of the first path may be suitable.

Additionally, to prevent the altering of the state of the electronic device 200 until the user is ready to use the electronic device 200, the electronic device 200 can include the appropriate programmatic functions to delay the alteration of its state. For instance, the electronic device 200 can include a software program, programmed within the logic circuitry or with the general software for operating the electronic device 200, that can delay the state alteration for some predetermined period, such as 1 second, after the device 200 is transformed to the open configuration. In such an arrangement, the delay software program may be triggered by a signal sent from a sensor that detects the pivoting of portion 210. For example, a programmatic delay (of up to a second, for example) can be used to delay the answering (or hanging up of) of a phone call when a user attempts to answer a ringing phone by flipping the phone open. This programmatic delay is useful when a user attempts to answer a call by opening the flip and mistakenly closes it temporarily before ultimately re-opening the phone. In this manner, the phone maintains the call signal even though the user pull it out of the carrier in an open position, closed it, and quickly attempts to open it again. Alternatively, the delay can be used to postpone termination of a call when flipping the phone closed and quickly re-opening it.

The present invention also provides a method or system of altering the state of an electronic device. The steps of the method are illustrated in a chart shown as FIG. 5. Although the chart illustrates the steps of method or system 500 in sequential order, there is no requirement as to the order of the steps, whether some steps are completed or skipped, or whether additional steps can be added. The method can begin at step 505.

In step 510, an electronic device having a pivotable portion can be provided. Method or system 500 is not limited as to the specific type of electronic device provided as any suitable device is appropriate.

In step 515, an electronic device carrier is provided. The carrier can include a base with a resting portion and a projection extending from the base and positioned to engage the electronic device. Again, method or system 500 is not limited as to the specific dimensions of the carrier provided as any suitable carrier, compatible with the electronic device, is suitable.

In step 520, the electronic device is selectively removed from the carrier along a first path to alter the state of the electronic device. Alternatively, the electronic device can be removed along a second path to purposely fail to alter the state of the electronic device.

With selectively removing the electronic device along the first path, method or system 500 can also include steps 525 and 530. In step 525, the pivotable portion of the electronic device can be engaged with the projection of the base. Consequently, the pivotable portion of the electronic device can be transformed to an open configuration to selectively alter the state of the electronic device in step 530.

Also, in step 535, the electronic device can be returned to the carrier so that the projection is positioned to engage the pivotable portion. The method or system 500 can end at step 540 or any of the steps of method or system 500 can be repeated in any suitable order.

This invention can be embodied in other forms without departing from the spirit or essential attributes thereof. For instance, although the electronic device is shown as a mobile phone, one skilled in the art would readily recognize that the invention can be used with a wide variety of electronic devices, such as radios, personal digital assistants, micro computers, and the like. Accordingly, reference should be made to the following claims, rather than to the foregoing specification, as indicating the scope of the invention.

We claim:

1. A portable electronic device carrier, comprising:
a base having a resting portion which slidably receives an electronic device for securing the electronic device in a stored position;
a projection extending from the base and positioned to engage the electronic device; and
wherein the projection selectively alters the state of the electronic device when the electronic device is removed from the stored position along a first path.

2. The portable electronic device according to claim 1, wherein the electronic device pivots to transform between open and closed configurations and the projection is positioned to engage a surface of the electronic device, the projection selectively transforms the electronic device to the open configuration when the device is removed from the stored position along the first path and fails to transform the electronic device to the open configuration when the device is removed from the stored position along a second path.

3. The portable electronic device according to claim 2, wherein the projection forms a hook that engages the electronic device at a channel formed by the meeting of pivoting portions of the electronic device.

4. The portable electronic device according to claim 2, wherein the projection forms a hook that engages the electronic device at an indentation formed on the electronic device at a meeting of the pivoting portions of the electronic device.

5. The portable electronic device according to claim 2, wherein the projection is biased such that the projection flexes to enable the electronic device to slide into the stored position and the projection returns to an un-flexed position to engage the surface of the electronic device.

6. The portable electronic device according to claim 2, wherein the base includes a top portion opposite to the resting portion, the projection is located between the top portion and the resting portion offset from the pivot of the electronic device.

7. A mobile electronic device for use with an electronic device holder, comprising:
a mobile electronic device slidable into an electronic device holder for securing the electronic device in a stored position, the electronic device having a pivotable portion;
wherein the pivotable portion aligns with a projection extending from a base of the electronic device carrier such that the pivotable portion is positioned to engage the projection;
whereby the pivotable portion is engaged by the projection to selectively alter the state of the electronic device when the electronic device is moved from the stored position along a first path.

8. The mobile electronic device according to claim 7, wherein the electronic device pivots to transform between open and closed configurations and the projection is positioned to engage a surface of the electronic device, the pivotable portion is engaged by the projection to selectively pivot the electronic device to the open configuration when the device is removed from the stored position along the first path and the pivotable portion is not engaged by the projection and fails to pivot the electronic device to the open configuration when the device is removed from the stored position along a second path.

9. The mobile electronic device according to claim 8, wherein the pivoting portion of the electronic device forms a channel at the point where the projection engages the electronic device.

10. The mobile electronic device according to claim 8, wherein the electronic device includes an indentation at the meeting of the pivoting portion of the electronic device where the projection engages the electronic device.

11. The mobile electronic device according to claim 10, wherein the indentation is offset from the pivot of the electronic device.

12. The mobile electronic device according to claim 8, wherein the electronic device includes a delay such that the state of the electronic device is altered after the commencement of the pivoting.

13. The mobile electronic device according to claim 7, wherein the electronic device carrier slidably receives the mobile electronic device for securing the electronic device in a stored position.

14. A system of altering the state of an electronic device, the system comprising:
an electronic device having a pivotable portion;
an electronic device carrier having a base with a resting portion and with a projection extending from the base and positioned to engage the electronic device;
means for altering the state of the electronic device when selectively removing the electronic device along a first path; and
means for purposely failing to alter the state of the electronic device when selectively removing the electronic device along a second path.

15. The system according to claim 14, wherein the means for altering comprises the projection when selectively engaging the pivotable portion of the electronic device to transform the pivotable portion of the electronic device to an open configuration.

16. The system according to claim 14, wherein the system is arranged and constructed to have the projection positioned to engage the pivotable portion when returning the electronic device to the carrier.
